(19) United States
(12) Patent Application Publication
(10) Pub. No.: US 2004/0024912 A1
(43) Pub. Date: Feb. 5, 2004

(54) Device-sharing system, device administration terminal, gateway terminal, device, terminal program and device program, and method for providing a device-sharing service

(76) Inventors: Akihito Fukao, Suwa-shi (JP); Shinya Taniguchi, Suwa-shi (JP); Senichi Mokuya, Suwa-shi (JP); Toru Takahashi, Chino-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/438,359

(22) Filed: May 14, 2003

(30) Foreign Application Priority Data
May 22, 2002 (JP) 2002-148242

(51) Int. Cl. G06F 15/16

(52) U.S. Cl. 709/249

(57) ABSTRACT

A device-sharing system easily shares devices in a network environment. When a device management server 100 receives a provide-service request, it identifies, based on service information, the network device 210 connected to the home gateway 200 and the network device 210 linked thereto to provide a service as service-related devices, and reads and returns service information for the service-related devices. When the gateway 200 receives the service information in reply to the provide-service request sent to the administration server 100, it displays a service list based on the received service information. When a service is selected from the displayed service list, the gateway relays communication between the device 210 connected to the gateway 200 and the identified service-related device based on the device-to-device communication information contained in the received service information for the selected service.

### BACKGROUND OF THE INVENTION

1. Field of the Invention

The present invention relates to a system for sharing devices and a terminal, device, programs, and methods adapted for that system, and relates more specifically to a device-sharing system useful for sharing devices, a device administration terminal, a gateway terminal, a device, a program for the terminal and a program for the device, and a method for providing a device-sharing service.

2. Description of the Related Art

It is expected that home gateways for connecting to the Internet will be common in the very near future. These home gateways will be connected directly to the Internet and have multiple ports for connecting multiple network devices to the gateway so that each network device can access Internet services through the home gateway. Typical of such network devices are network-enabled scanners and printers.

Such networks will enable network devices in the home to access Internet servers as well as network devices in other homes. An example of the latter is when home A has a network-enabled scanner connected to its home gateway, home B has a network printer connected to its home gateway, and a user in home A wants to send a document by fax to home B. To send the fax the user scans the document with the network scanner in home A, and the network scanner then sends the document through the gateways in homes A and B to the network printer in home B.

In order to use a network device in another home, however, the address assigned to the destination home gateway must first be acquired to enable communication. This makes it necessary to either install a special application or set special network settings in the home gateway or network device. Both of these can be complicated for non-technical users.

Furthermore, even if some other technology is used to make the network settings or software installation easier, the network devices in one home are not necessarily able to use all other network devices, and each other network device must be individually queried to determine whether the device can be used in order to expand the range of usable devices. Expanding the range of usable network devices can therefore be time-consuming and difficult.

Furthermore, even if it is possible to automatically query other network devices to determine their usability, it is still difficult to query unknown network devices. This limits how far the range of usable devices can be expanded.

### OBJECTS OF THE INVENTION

The present invention is therefore directed to solving these unresolved problems of the prior art described above. Accordingly, an object of the invention is to provide a device-sharing system useful for sharing devices, a device administration terminal, a gateway terminal, a device, a program for the terminal and a program for the device, and a method for providing a device-sharing service.

### SUMMARY OF THE INVENTION

According to a first aspect of the present invention, a device-sharing system is provided. The device-sharing system enables communication between a device administration terminal and a plurality of gateway terminals, each associated with at least one device and configured to establish communication between the at least one associated device and other devices through their respective gateway terminals. Each device in the system is able to perform or receive one or more of a plurality of services available on the system.

The system comprises a service information storage medium configured to store, for each service, information relating to that service including device-to-device communication information enabling communication between devices used for that service. When the device administration terminal receives a provide-service request, the device administration terminal identifies as service-related devices (i) a device of the gateway terminal from which the provide-service request originated and (ii) at least one device linked thereto to perform the requested service, based on service information from the service information storage medium, and reads service information for the service-related devices from the service information storage medium, and sends the read service information for the service-related devices to the request-originating gateway terminal. Then, upon receiving service information from the device administration terminal in response to the request, the gateway terminal from which the provide-service request originated displays a service list based on the received service information, and, when a service is selected from the displayed service list, relays communication between the gateway terminal device from which the provide-service request originated and the at least one device linked thereto to obtain performance of the requested service, based on device-to-device communication information contained in the received service information for the selected service.

Thus, with this configuration, when a provide-service request is received, the device(s) requesting service, is/are connected to one or more devices designated to provide the requested service, so that they can communicate with each other. By enabling each device in the system to obtain services from other devices in the system the functionality of each device is greatly enhanced.

Services are broadly defined as any service capable of being identified by a provide-service request, performed by at least one device in the system, and received by at least one device in the system.

The system of this invention can be achieved as stand-alone system, or as part of a larger network system.

The device administration terminal can be any communication device able to communicate with a plurality of gateway terminals and having at least a server function. The device administration terminal could also have both a client function and a server function.

The device-sharing system also preferably comprises a group information storage medium for storing group information relating to groups to which multiple devices belong. When a provide-service request is received, the device administration terminal reads from the group information storage medium group information for the group to which the device of the provide-service-originating gateway terminal belongs, and, based on the read group information and service information from the service information storage medium, identifies the service-related devices from that same group.

Preferably, the service information includes application information denoting a location from which an application to be applied to a device or gateway terminal used in the service can be acquired. When a service is selected from the service list, the gateway terminal acquires an application based on application information contained in the received service information for the selected service, and applies the acquired application to the device or gateway terminal.

In another aspect of the invention, a device-sharing system for enabling communication between any of a plurality of devices, each being able to perform or receive one or more of a plurality of services available on the system, is provided. The system is configured such that, in response to a provide-service request received by a device administration terminal, it establishes a communication link between at least one device designated to perform the service requested and at least one device designated to receive the requested service.

The device-sharing system comprises a service information storage medium for storing, for each service, service information relating to that service. The service information includes device-to-device communication information enabling communication between devices used for that service.

When the device administration terminal receives a provide-service request, it identifies as service-related devices a device from which the provide-service request originated and at least one device linked thereto to perform the requested service, based on service information read from the service information storage medium, and reads service information for the service-related devices from the service information storage medium, and sends the read service information to the request-originating device.

Upon receiving service information in response to the request, the provide-service-originating device displays a service list based on the received service information. When a service is selected from the displayed service list, and, when a service is selected from the displayed service list, the device communicates with the at least one device linked thereto to obtain performance of the requested service, based on device-to-device communication information contained in the received service information for the selected service.

The device in this aspect of the invention sends the provide-service request to the device administration terminal. When the device administration terminal receives the request, it provides the requesting device with a list of services available, and upon selection of a service links up a device to provide the requested service using its available resources.

According to another aspect of the invention, a device administration terminal is provided. The device administration terminal is for use in a device-sharing system, such as that described above, and is in communication with a plurality of gateway terminals, each having at least one device associated therewith, or in direct communication with the devices themselves.

The device administration terminal comprises a service information storage medium configured to store, for each service, information relating to that service including device-to-device communication information enabling communication between devices used for that service. When a provide-service request is received by the device administration terminal, the device administration terminal identifies as service-related devices (i) the device, or its associated gateway terminal, from which the provide-service request originated and (ii) at least one device linked thereto to perform the requested service, based on service information from the service information storage medium, and reads service information for the service-related devices including device-to-device communication information from the service information storage medium, and sends the read service information to the request-originating gateway terminal or device itself.

Another aspect of this invention relates to a gateway terminal for use in a device-sharing system of the type described above. The gateway terminal establishes communication between a device associated therewith and other devices, each of which is able to perform or receive one or more services.

The gateway terminal comprises a service information storage medium configured to store, for each service, information relating to the service including device-to-device communication information enabling communication between devices used for the service. The gateway terminal is configured to send a provide-service request to an external device, receive service information in response to the sent request, display a service list based on the received service information, and in response to a service being selected from the displayed service list, relay communication between the gateway terminal device and a service-related device based on device-to-device communication information contained in the received service information relating to the selected service.

In another aspect, a device capable of participating a device-sharing system with other devices as described above is provided. The device is configured to send a provide-service request to the device administration terminal, receive service information in response to the sent request, display a service list based on the received service information, and in response to a service being selected from the displayed service list, communicate with at least one service-related device based on device-to-device communication information contained in the received service information for the selected service.

In other aspects of the invention, various programs adapted to be run by a device terminal, a gateway terminal, and a device are provided. Each such program is embodied on a device-readable medium and provides appropriate instructions for bringing about the above-described functionalities of its host component.

Another aspect of the invention involves methods of providing a device-sharing service. The methods are commensurate with the functions of the corresponding device-sharing systems described above.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic block diagram of a network system to which the present invention is applied;

FIG. 2 is a block diagram showing the configuration of the device management server 100;

FIG. 3 is a table showing the data structure of the user information database 40;

FIG. 4 is a table showing the data structure of the device information database 41;

FIG. 5 is a table showing the device-sharing of the service information database 42;

FIG. 6 is a table showing the data structure of the group information database 43;

FIG. 7 is a flow chart showing the user information registration process;

FIG. 8 is a flow chart showing the device information registration process;

FIG. 9 is a flow chart showing the service information registration process;

FIG. 10 is a flow chart showing the group information registration process;

FIG. 11 is a flow chart showing the join-group process;

FIG. 12 is a flow chart showing the first service-information-providing process;

FIG. 13 is a flow chart showing the second service-information-providing process;

FIG. 14 is a block diagram showing the configuration of a home gateway;

FIG. 15 is a flow chart showing the user information registration request process;

FIG. 16 is a flow chart showing the device information registration request process;

FIG. 17 is a flow chart showing the service information registration request process;

FIG. 18 is a flow chart showing the group information registration request process;

FIG. 19 is a flow chart showing the join-group request process;

FIG. 20 is a flow chart showing the first service-providing process; and

FIG. 21 is a flow chart showing the second service-providing process.

### DESCRIPTION OF THE PREFERRED EMBODIMENTS

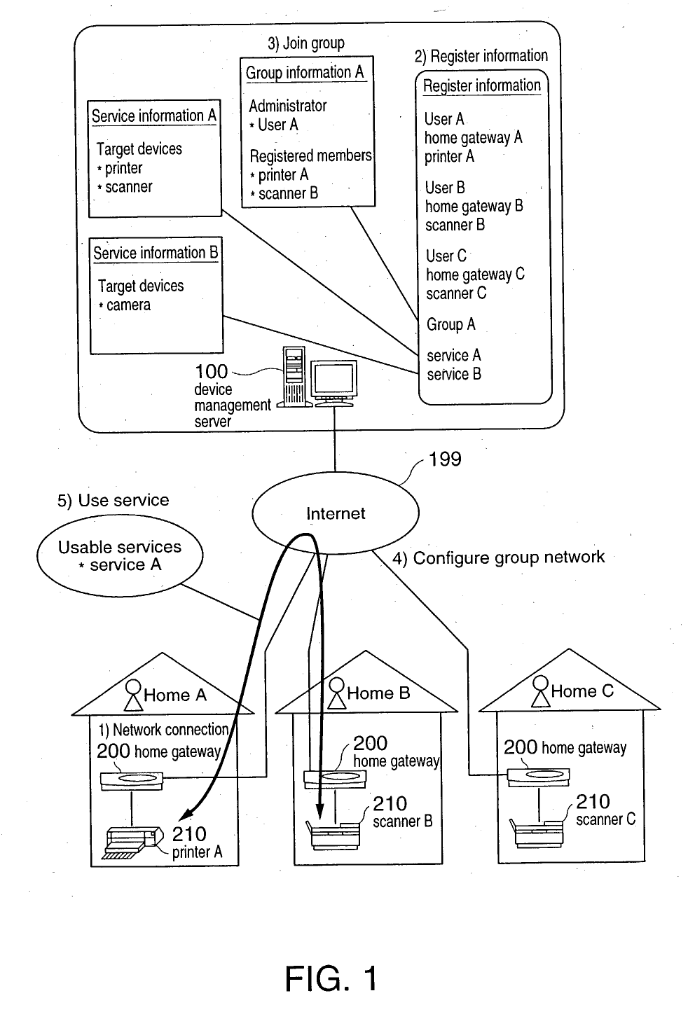

Preferred embodiments of the present invention are described below with reference to the accompanying figures. FIG. 1 to FIG. 21 show various embodiments of the a device-sharing system, a device administration terminal, a gateway terminal, a device, a program for the terminal and a program for the device, and a method for providing a device-sharing service according to the present invention.

As shown in the drawings, a device-sharing system, a device administration terminal, a gateway terminal, a network-enabled device, programs for the terminal and the device, and a method for providing a device-sharing service according to the present invention are employed to define multiple services achieved by linking at least two of multiple network-enabled devices 210 located in individual homes A, B, and C, to connect the necessary network devices 210 according to a provide-service request, and to provide services using these network devices 210.

First, the configuration of a network system for deploying the present invention is described with reference to FIG. 1, which is a schematic block diagram of a network system to which the present invention is applied.

As shown in FIG. 1, each home A, B and C has a home gateway 200 that is in communication with at least one network device 210 in the same home. Examples of such network devices 210 include a network-enabled scanner and network-enabled printer. In the example shown in FIG. 1, a network-enabled printer is located in home A, and a network-enabled scanner is installed in each of homes B and C.

A device management server 100 is able to manage the network devices 210 and home gateways 200 via the Internet 199, or through other suitable remote communication means.

The configuration of the device management server 100 is described in detail next with reference to the block diagram of FIG. 2. As shown in FIG. 2, the device management server 100 is composed of a CPU 30 for controlling operations of the system based on a control program which may be stored at a predetermined address in ROM 32 which may also store other data. RAM 34 stores data read from ROM 32 and the required results of operations performed by CPU 30, and an interface 38 exchanges data with various databases and external devices. The components of the device management server 100 are connected to a common data bus 39 for transferring data therebetween.

Databases in communication with the interface 38 include a user information database 40 for storing user information about the users, a device information database 41 for storing device information relating to the network devices 210, a service information database 42 for storing service information relating to available services, a group information database 43 for storing group information relating to the groups to which a plurality of users or network devices 210 belong, and an application database 44 for storing applications usable by the home gateways 200. Also in communication with the interface 38 is a communication path for connecting the device administration server 100 to the Internet 199.

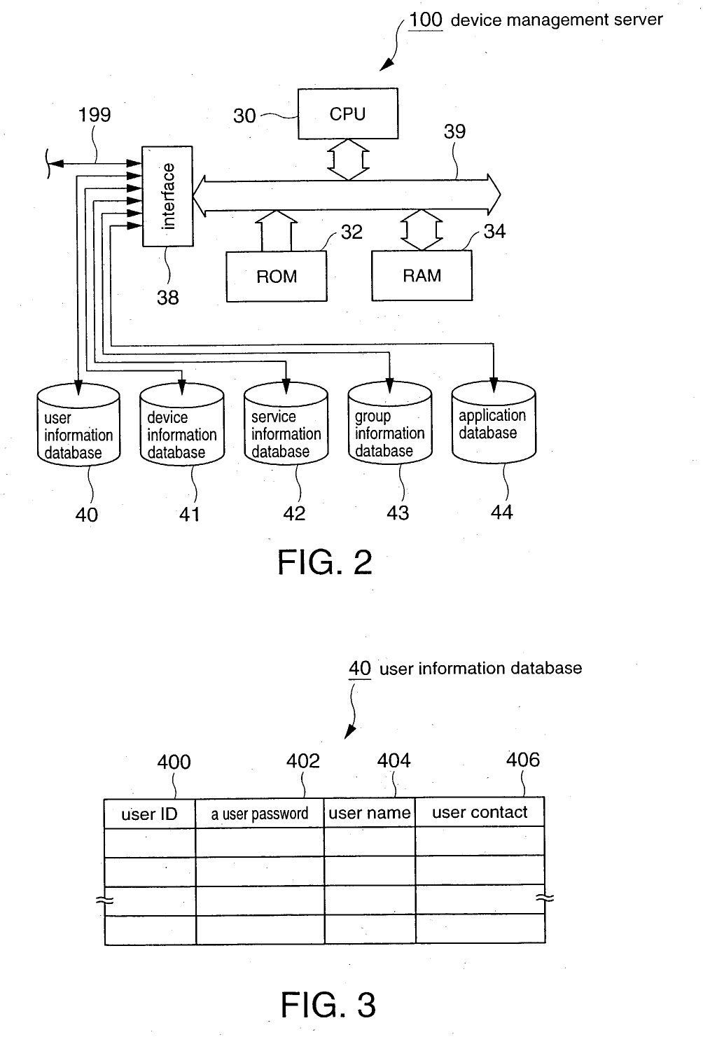

The data structure of the user information database 40 is described in detail next with reference to FIG. 3, which is a table showing the data structure thereof. A user could be the owner of a home gateway 200 or network device 210, or a service vendor. The user information database 40 stores one record per user as represented by the lines in FIG. 3. Each record contains the following fields shown as columns in FIG. 3: a user ID field 400 for storing a unique ID for a particular user, a user password field 402, a user name field 404, and a user contact field 406.

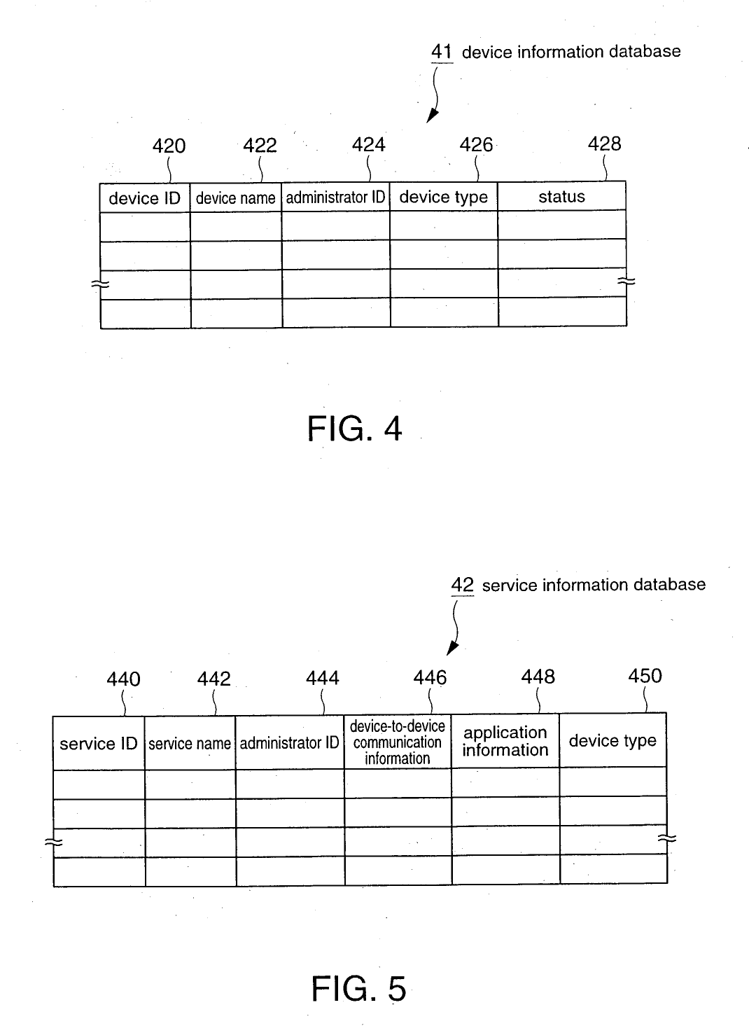

The data structure of the device information database 41 is described in detail next with reference to FIG. 4, which is a table showing the data structure thereof. As shown in FIG. 4, the device information database 41 similarly stores one record per network device 210. Each record has the following fields: a device ID field 420 for storing a unique ID for each network device 210, a network device name field 422, an administrator ID field 424 for identifying the user that is the administrator for the network device 210, a device type field 426 for storing the type of network device 210, and a status field 428 for storing the status of the network device 210. The information stored in fields 422, 426, and 428 is acquired from the particular network device 210 by means of communication with that network device 210.

The data structure of the service information database 42 is described in detail next with reference to FIG. 5, which is a table showing the data structure thereof As shown in FIG. 5, the service information database 42 likewise stores one record per service. Each record has the following fields: a service ID field 440 for storing a unique ID identifying the particular service, a service name field 442, an administrator ID field 444 identifying the administrator of that service, a device-to-device communication information field 446 for storing information enabling communication between network devices using the service, an application information field 448 for storing the location from which the application can be acquired, and a device type field 450 for storing the type of network device 210.

The global IP address, for example, assigned to the home gateway 200 to which a particular network device 210 is connected is stored in the device-to-device communication information in field 446.

The URL (Universal Resource Locator) of the Web server, where the application is stored, is stored as the application information in field 448, for example. It is not essential that application information be stored; it could be stored only when a special application is needed on the home gateway 200 side to provide the service.

Services as defined in this embodiment of the invention are achieved by linking at least two network devices 210. Multiple network devices 210 used for the service are defined for each service, and device-to-device communication information enabling such network devices 210 to talk with each other is also defined. To provide a particular service, the network devices 210 defined for that service are communicatively connected to link the device together and thereby achieve some particular function. The device-to-device communication information 446 is required to communicatively connect the network devices 210. In other words, one network device 210 used in the service communicates with another network device 210 used for the same service based on the device-to-device communication information. An example of a service is a fax service which can be achieved by linking a network-enabled scanner and a network-enabled printer.

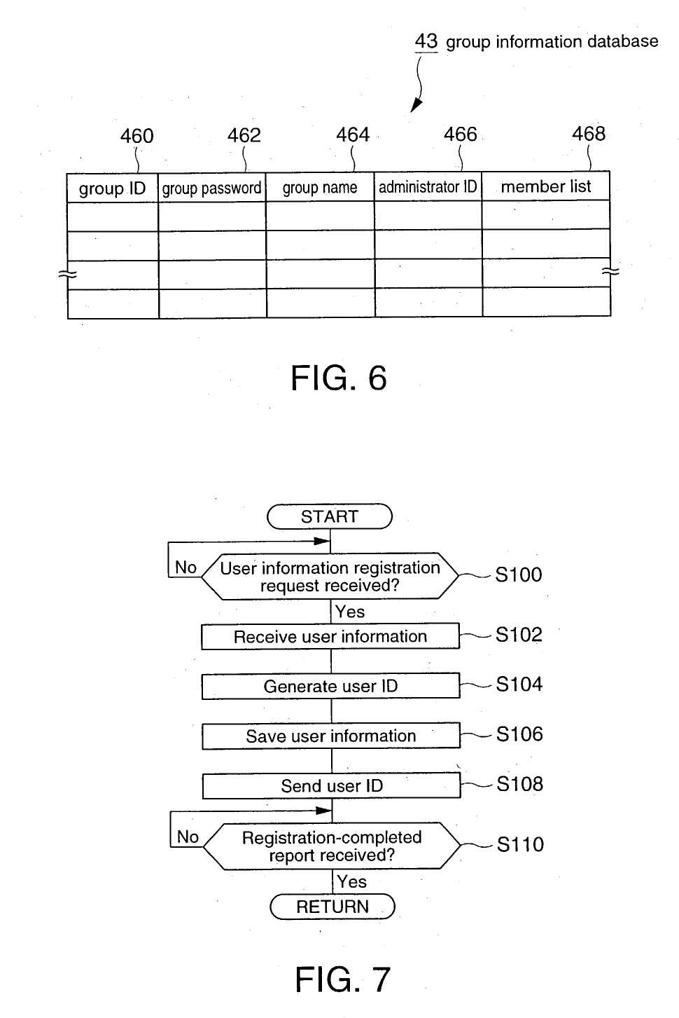

The data structure of the group information database 43 is described next in detail with reference to FIG. 6, which is a table showing the data structure thereof. The group information database 43 also stores one record per group as shown in FIG. 6. Each record has the following fields: a group ID field 460 for storing a group ID uniquely identifying the group, a group password field 462, a group name field 464, an administrator ID field 466 for storing the user ID of the user that is the group administrator, and a member list field 468 for storing all members of the group.

The user ID of each user belonging to the group, or the device ID of each network device 210 associated with the group, is stored as a member list in the member list field 468. It should be noted that one or multiple user IDs or device IDs could be stored to the member list field 468.

Referring again to FIG. 2, the CPU 30 functions as a microprocessing unit (MPU) that starts a specific program stored at a specific address in ROM 32 to execute on a time-share basis according to this program processes such as those shown in the flow charts in FIG. 7 to FIG. 13. More specifically, these processes are a user information registration process, a device information registration process, a service information registration process, a group information registration process, a join-group process, a first service-information-providing process, and a second service-information-providing process.

These processes are described next starting with the user information registration process shown FIG. 7, which is a flow chart showing that process. The user information registration process stores user information in the user information database 40 at a user information registration request from the home gateway 200.

When the user information registration process is called by the CPU 30 it starts from step S100 as shown in FIG. 7. Whether a user information registration request was received is first determined in step S100. If it was (yes), control goes to step S102. Otherwise (no), the process waits at step S100 until a registration request is received.

The user information (except for the user ID) is then received in step S102, and a unique user ID that does not duplicate any other user ID is generated in step S104. The user information including both the received user information and the generated user ID is then stored as one user information record in the user information database 40 in step S106. The generated user ID is then sent to the home gateway 200 of the requesting terminal in step S108, and control goes to step S110.

Whether a registration-completed report was received is determined in step S110. If it was (yes), the user information registration process ends and control returns to the previous process. If it was not received (no), step S110 repeats until the registration-completed report is received.

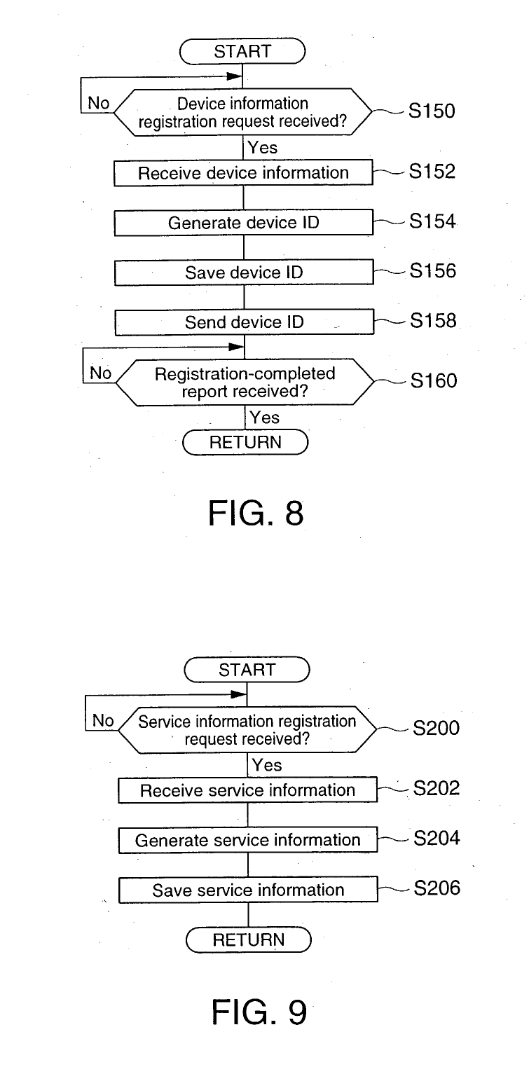

The device information registration process is described in detail next with reference to FIG. 8, which is a flow chart showing that process. The device information registration process is for registering device information to the device information database 41 in response to a registration request from the home gateway 200.

This process starts from step S150 when it is called by the CPU 30. Whether a device information registration request was received is first determined in step S150. If the registration request was received (yes) control goes to step S152, but otherwise (no) step S150 repeats until the registration request is received.

In step S152 the device information (except for the device ID) is received and a device ID that does not duplicate any other device ID is then generated in step S154. The received device information and the generated device ID are then stored as one device information record in the device information database 41 (step S156) and the generated device ID is sent to the home gateway 200 of the requesting terminal in step S158. Control then goes to step S160.

Whether a registration-completed report was received is then detected in step S160. If the registration-completed report was received (yes), the device information registration process ends and control returns to the previous process. If the report was not received (no), step S160 repeats until the registration-completed report is received.

The service information registration process is described in detail next below with reference to FIG. 9, which is a flow chart showing that process. The service information registration process is a process for storing service information in the service information database 42 in response to a registration request from the home gateway 200.

When the process is run by the CPU 30 it starts from step S200 as shown in FIG. 9. Whether a service information registration request was received is first determined in step S200. If it was (yes), control goes to step S202. Otherwise (no), step S200 repeats until a registration request is received.

In step S202 the service information (not including the service ID) is received and a unique service ID not duplicating any other service ID is then generated in step S204. The received service information and generated service ID are then stored as one service information record to the service information database 42 in step S206, the process ends and control returns to the previous process.

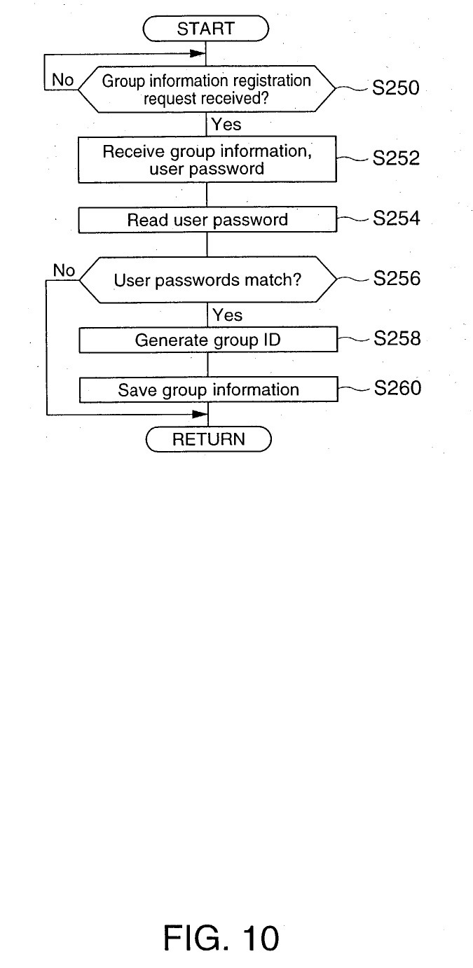

The group information registration process is described in detail next with reference to FIG. 10, which is a flow chart showing that process. The group information registration process is a process for storing the group information in the group information database 43 in response to a registration request from the home gateway 200.

When the process is run by the CPU 30 it starts from step S250 as shown in FIG. 10. Whether the group information registration request was received is first determined in step S250. If it was (yes), control goes to step S252, but otherwise (no) step S250 repeats until the registration request is received.

The group information (not including the group ID) and user password are then received in step S252, and the user password corresponding to the administrator ID contained in the received group information is read from the user information database 40 in step S254. Control then goes to step S256.

In step S256 the received user password is compared with the user password read from the database. If the passwords are the same (step S256 returns yes), a unique group ID that does not duplicate any other group ID is generated in step S258. The received group information and generated group ID are then stored as one group information record in the group information database 43 in step S260, the registration process ends, and control returns to the previous process. However, if the received password and the user password read from the database do not match in step S256 (no), the process ends and control returns to the previous process.

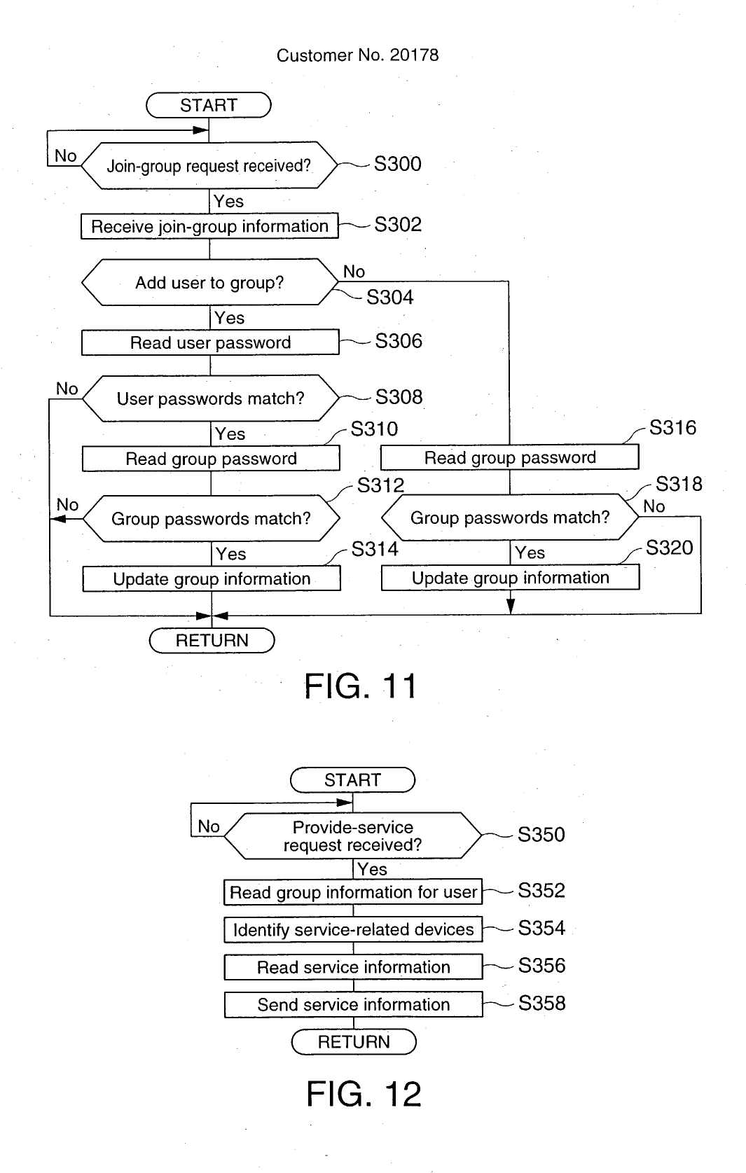

The join-group process is described next in detail with reference to FIG. 11, which is a flow chart showing that process. The join-group process enables a user or network device 210 to join a group according to a join-group request from the home gateway 200.

When the process is run by the CPU 30 it starts from step S300 as shown in FIG. 11. Whether a join-group request was received is determined in step S300. If it was (step S300 returns yes), control goes to step S302, but otherwise (no) step S300 repeats until a join-group request is received.

Join-group information including at least a group name and group password is received in step S302. Whether a user ID or a device ID is contained in the received join-group information is then determined in step S304. If a user ID was contained in the join-group information (step S304 returns yes), control goes to step S306.

The user password corresponding to the user ID contained in the join-group information is then read from the user information database 40 in step S306. Whether the user password in the join-group information matches the user password read from the user information database 40 is then determined in step S308. If the passwords match (step S308 returns yes), control goes to step S310.

The group password corresponding to the group name in the join-group information is then read from the group information database 43 in step S310. Whether the group password in the join-group information matches the group password read from the database is then checked in step S312. If these group passwords match (step S312 returns yes), the group information in the group information database 43 is updated by writing the user ID in the join-group information to the member list of the corresponding group information record in step S314. The process then ends and control returns to the previous process.

If the group password contained in the join-group information and the group password read from the database are determined in step S312 to not match (step S312 returns no), the process ends and control returns to the previous process. Furthermore, if the user password contained in the join-group information and the user password read from the database are determined in step S308 to not match (step S308 returns no), the process ends and control returns to the previous process.

Furthermore, if it is determined in step S304 that a device ID is contained in the join-group information instead of a user ID (step S304 returns no), control goes to step S316, the group password corresponding to the group name contained in the join-group information is read from the group information database 43, and control then goes to step S318.

Whether the group password contained in the join-group information and the group password read from the database match is then determined in step S318. If the group passwords match (step S318 returns yes), control goes to step S320. The group information in the group information database 43 is then updated by writing the device ID contained in the join-group information to the member list of the corresponding group information record. The process ends and control returns to the previous process.

If in step S318 the group password in the join-group information does not match the group password read from the database (step S318 returns no), the process ends and control returns to the previous process.

The first service-information-providing process is described in detail next with reference to FIG. 12, which is a flow chart showing that process. In response to a request from a home gateway 200, the first service-information-providing process provides service information from the service information database 42 to the requesting home gateway 200.

When the process is run by the CPU 30 it starts from step S350 as shown in FIG. 12. Whether a provide-service request was received is determined in step S350. If a request was received (yes), control goes to step S352, but otherwise (no) step S350 repeats until a request is received.

The group information for the group to which the user of home gateway 200 that sent the provide-service request is then read from the group information database 43 in step S352. A network device 210 connected to home gateway 200 and a network device 210 linked thereto to provide the service are identified from among the network devices 210 belonging to users in the same group based on the read group information and the service information in the service information database 42 as service-related devices in step S354, and control then goes to step S356.

The service information for the service-related devices is then read from the service information database 42 in step S356. Control then goes to step S358 whereby the read service information is sent to the home gateway 200 from which the request was received. The process then ends and control returns to the previous process.

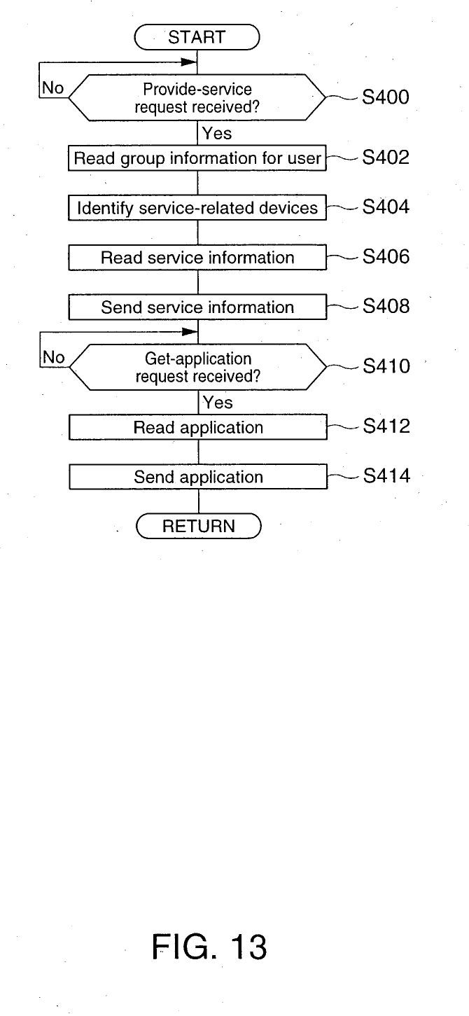

Next, the second service-information-providing process is described in detail with reference to FIG. 13, which is a flow chart showing that process. It should be noted that this second service-information-providing process differs from the first service-information-providing process in that it sends an application to the home gateway 200. In response to a request from a home gateway 200, the second service-information-providing process provides service information from the service information database 42 to the requesting home gateway 200.

When the process is run by the CPU 30 it starts from step S400 as shown in FIG. 13. Whether a provide-service request was received is determined in step S400. If a request was received (yes), control goes to step S402, but otherwise (no) step S400 repeats until a request is received.

The group information for the group to which the user of home gateway 200 that sent the provide-service request is then read from the group information database 43 in step S402. A network device 210 connected to home gateway 200 and a network device 210 linked thereto to provide the service are identified from among the network devices 210 belonging to users in the same group based on the read group information and the service information in the service information database 42 as service-related devices, and control then goes to step S406.

The service information for the service-related devices is then read from the service information database 42 in step S406. Control then goes to step S408 whereby the read service information is sent to the home gateway 200 from which the request was received. The process ends then goes to step S410.

Whether a get-application request was received is then determined in step S410. If a get-application request was received (step S410 returns yes), control goes to step S412, but otherwise (no) step S410 repeats until a get-application request is received.

In step S412 the application identified by the get-application request is read from the application database 44, and the retrieved application is then sent to the home gateway 200 from which the request was received in step S414. The process then ends and control returns to the previous process.

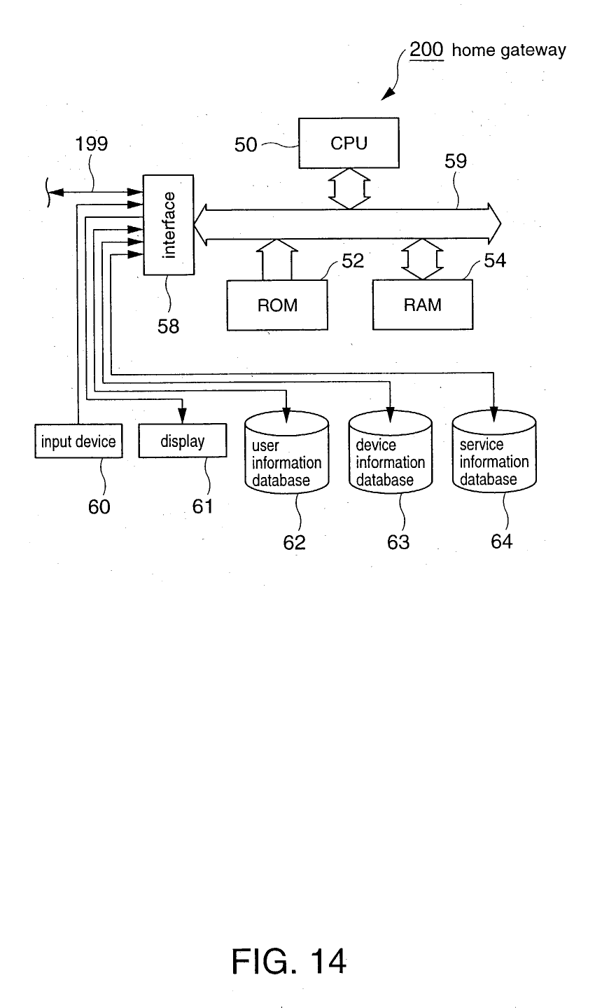

The configuration of the home gateway 200 is described in detail next below with reference to FIG. 14, which is a block diagram showing such configuration. As shown in FIG. 14, this home gateway 200 includes a CPU 50 for performing operations and controlling the overall system based on a specific control program, ROM 52 for storing the control program at a specific memory address, RAM 54 for storing data read from ROM 52 and the results of operations required for the operation of the CPU 50, and an interface 58 enabling the exchange of data with external devices. These components are connected to a common data bus 59 for transferring data therebetween.

Connected to the interface 58 are an input device 60 such as a keyboard or mouse as the human interface for entering data, a display 61 for displaying information based on an applied image signal, a user information database 62 for storing user information, a device information database 63 for storing device information, a service information database 64 for storing service information, and a communication path for connecting to the Internet 199.

It should be noted that the data structures used in the user information database 62, device information database 63, and service information database 64 are the same as those used in the user information database 40, device information database 41, and service information database 42, respectively.

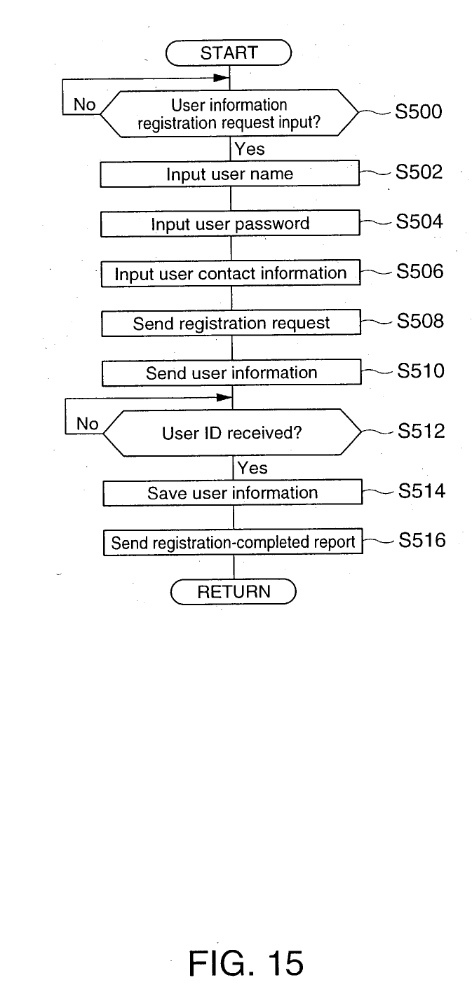

The CPU 50 functions as a microprocessing unit (MPU) that starts a specific program stored to a specific address in ROM 52 to execute on a time-share basis according to this program processes such as shown in the flow charts in FIG. 15 to FIG. 21. More specifically, these processes are a user information registration request process, a device information registration request process, a service information registration request process, a group information registration request process, a join-group request process, a first service-providing process, and a second service-providing process.

The user information registration request process is described first below with reference to FIG. 15, which is a flow chart showing that process. The user information registration request process corresponds to the user information registration process shown in FIG. 7.

When this process is run by the CPU 50, it starts from step S500 as shown in FIG. 15. Whether a user information registration request was input from the input device 60 is first determined in step S500. If a registration request was input (step S500 returns yes), control goes to step S502, but otherwise (no) step S500 repeats until a registration request is detected.

A user name is then input from the input device 60 in step S502, the user password is input from the input device 60 in step S504, and user contact information is input from the input device 60 in step S506. Control then goes to step S508.

The user information registration request is sent to the device management server 100 in step S508, and the user information input in steps S502 to S506 is sent to the device management server 100 in step S510.

Then in step S512 it is determined whether the user ID was received. If the user ID was received (step S512 returns yes), control goes to step S514, but otherwise (no) step S512 repeats until the user ID is received.

The received user ID and the user information input in steps S502 to S506 is then registered as one user information record to the user information database 62. A registration-completed report, indicating that storing the user information was successfully completed, is then sent to the device management server 100 in step S516, the process ends and control returns to the previous process.

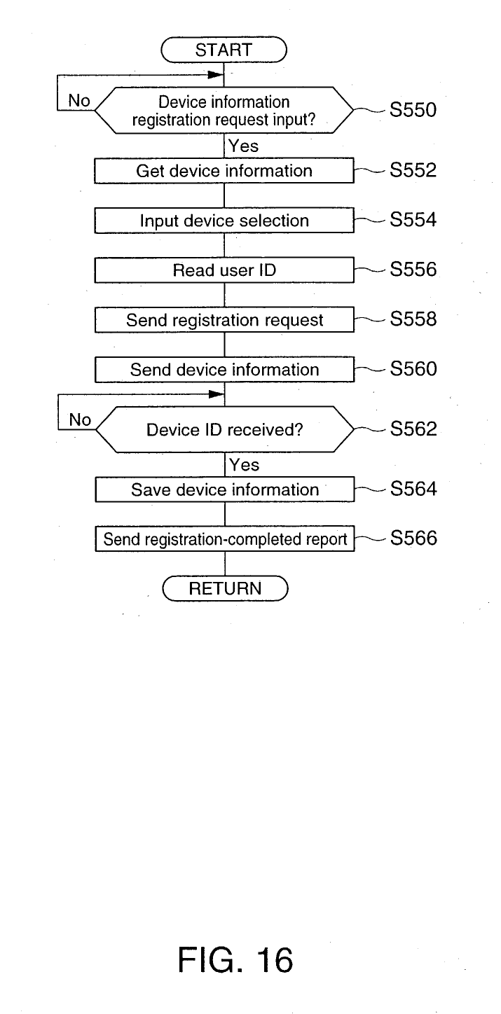

The device information registration request process is described in detail next with reference to FIG. 16, which is a flow chart showing that process. The device information registration request process corresponds to the device information registration process shown in FIG. 8.

When this process is run by the CPU 50, it starts from step S550 as shown in FIG. 16. Whether a device information registration request was input from the input device 60 is determined in step S550. If a registration request was input (step S550 returns yes), control goes to step S552 but otherwise (no) step S550 repeats until a registration request is input.

In step S552 the device information is acquired from network device 210 by communication with the network device 210 connected to the home gateway 200. More specifically, the name, type, and status of the network device 210 are acquired as the device information in step S552.

Next, in step S554, the user is requested to select the network device 210 that is to be registered from among the network devices 210 connected to the home gateway 200. The network device 210 selection is then input from the input device 60 and control goes to step S556.

The user ID is then read from the user information database 62 in step S556 and the read user ID is acquired as the administrator ID. A device information registration request is then sent to the device management server 100 in step S558, the device information acquired in steps S552 and S556 is sent to the device management server 100 in step S560, and control goes to step S562.

Whether the device ID was received is then determined in step S562. If it was (yes), control goes to step S564, but if not (no) step S562 repeats until the device ID is received.

In step S564 the received device ID and the device information acquired in steps S552 and S556 are saved as one device ID record to the device information database 63. A registration-completed report is then sent to the device management server 100 in step S566. The process then ends and control returns to the previous process.

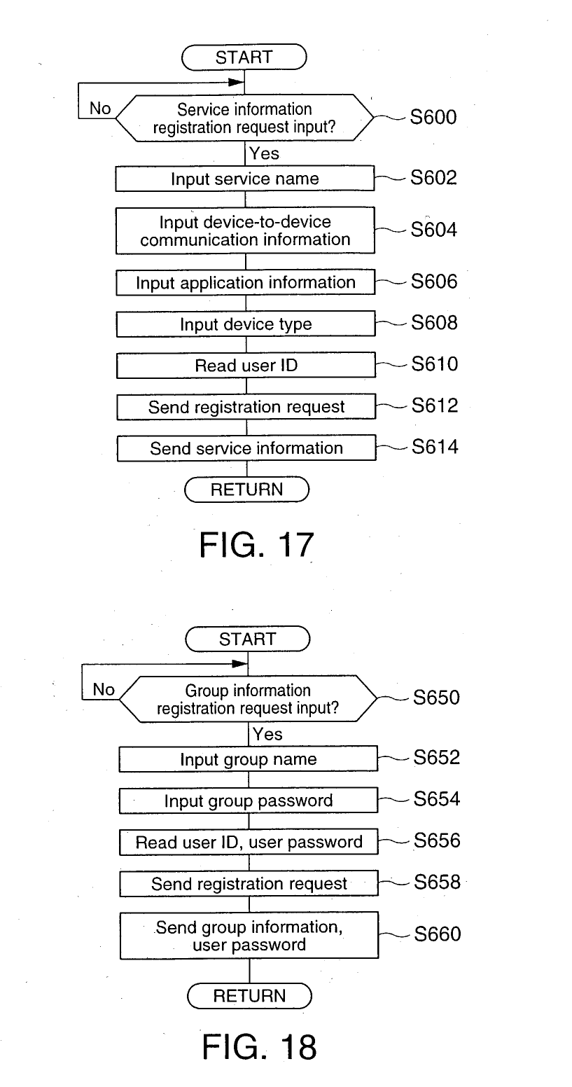

The service information registration request process is described in detail next with reference to FIG. 17, which is a flow chart showing that process. The service information registration request process corresponds to the service information registration process shown in FIG. 9.

When this process is run by the CPU 50, it starts from step S600 as shown in FIG. 17. Whether a service information registration request was input from the input device 60 is determined in step S600. If a registration request was input (yes), control goes to step S602 but otherwise (no) step S600 repeats until a registration request is input.

The service name is then input from the input device 60 in step S602 and control goes to step S604. The device-to-device communication information is then input from the input device 60, the application information is input from the input device 60 in step S606, and the type of network device 210 used in the service is input from the input device 60 in step S608. Control then goes to step S610.

The user ID is then read from the user information database 62 in step S610 and acquired as the administrator ID. A service information registration request is then sent to the device management server 100 in step S612, and the service information input in steps S602 to S610 is sent to the device management server 100. The process then ends and control returns to the previous process.

The group information registration request process is described in detail next with reference to FIG. 18, which is a flow chart showing that process. The group information registration request process corresponds to the group information registration process shown in FIG. 10.

When this process is run by the CPU 50, it starts from step S650 as shown in FIG. 18. Whether a group information registration request was input from the input device 60 is determined in step S650. If a registration request was input (yes), control goes to step S652 but otherwise (no) step S650 repeats until the registration request is input.

In step S652 the group name is input from the input device 60, the group password is input from the input device 60 in step S654, and the user ID and group password are read from the user information database 62 in step S656. The read user ID is acquired as the administrator ID and control goes to step S658.

A group information registration request is then sent to the device management server 100 in step S658, and in step S660 the group information input in steps S652 to S656 and the user password read in step S656 are sent to the device management server 100. The process then ends and control returns to the previous process.

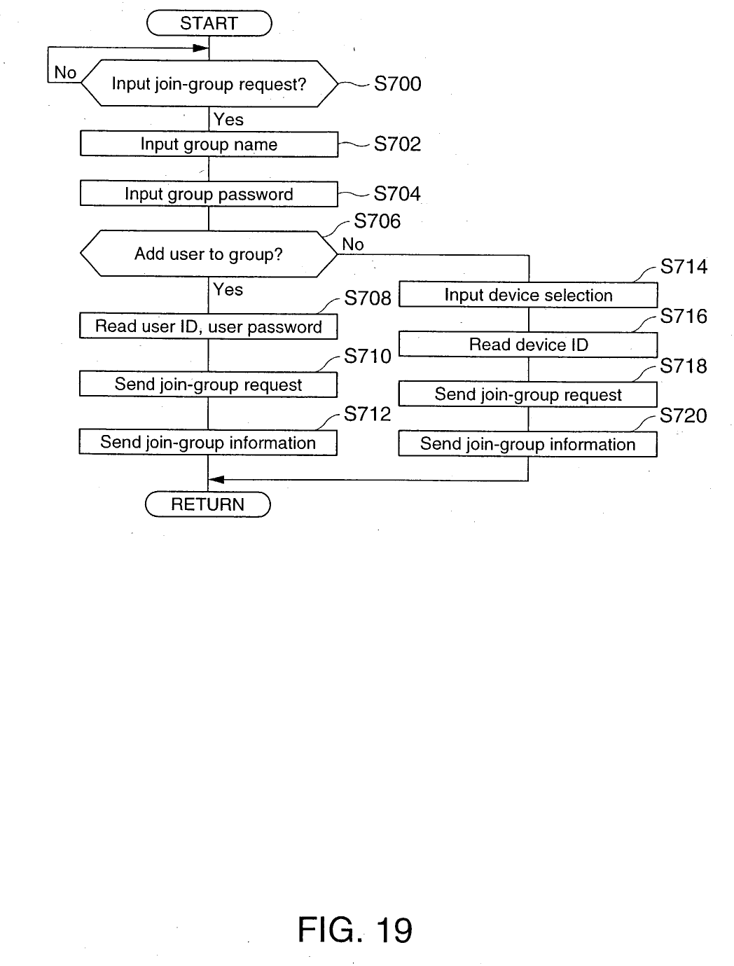

The join-group request process is described in detail next with reference to FIG. 19, which is a flow chart showing that process. The join-group request process corresponds to the join-group process shown in FIG. 11.

When this process is run by the CPU 50, it starts from step S700 as shown in FIG. 19. Whether a join-group request was input from the input device 60 is determined in step S700. If a join-group request was input (yes), control goes to step S702 but otherwise (no) step S700 repeats until a join-group request is input.

The group name is then input from the input device 60 in step S702, the group password is input from the input device 60 in step S704, and control goes to step S706.

Based on command input from the user, whether a user joins the group or whether a network device 210 joins the group is determined in step S706. The user ID and user password are then read from the user information database 62 in step S708, and control then goes to step S710. The join-group request is then sent to the device management server 100 in step S710, and the group name, group password, user ID, and user password acquired in steps S702, S704, and S708 are sent to the device management server 100 as the join-group information in step S712. The process then ends and control returns to the previous process.

If step S706 determines that a network device 210 is to participate in the group (step S706 returns no), control goes to step S714 and the user is requested to select the network device 210 connected to the home gateway 200 that is to participate in the group. The network device 210 selection is then input from input device 60, the device ID of the selected network device 210 is read from the device information database 63, and control goes to step S718.

In step S718 the join-group request is sent to the device management server 100. The group name, group password, and device ID input in steps S702, S704, and S716 are then sent to the device management server 100 as the join-group information in step S720. The process then ends and control returns to the previous process.

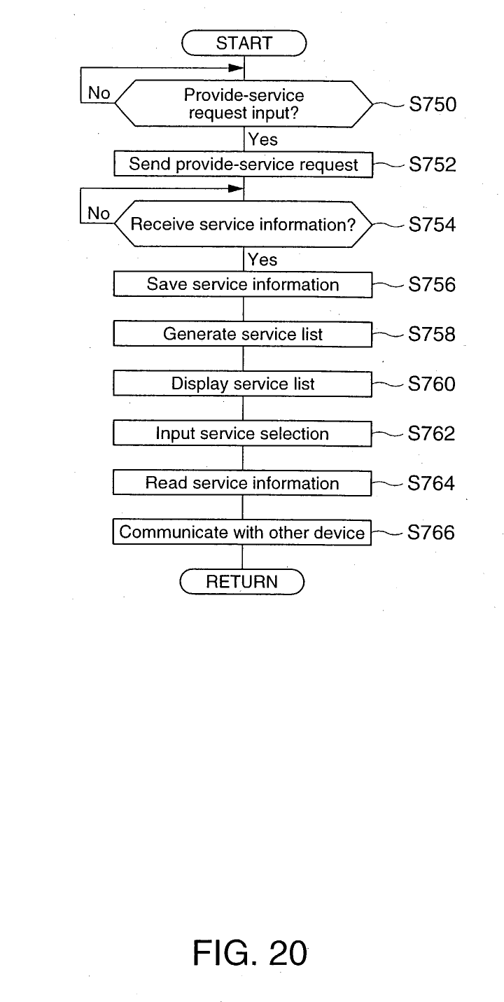

The first service-providing process is described in detail next with reference to FIG. 20, which is a flow chart showing that process. The first service-providing process corresponds to the first service-information-providing process shown in FIG. 12.

When this process is run by the CPU 50, it starts from step S750 as shown in FIG. 20. Whether a provide-service request was input from the input device 60 is determined in step S750. If a service request was input (yes) control goes to step S752, but otherwise (no) step S750 repeats until a provide-service request is input.

In step S752 the provide-service request is sent to the device management server 100 and whether service information was received is determined in step S754. If service information was received (step S754 returns yes), control goes to step S756, but otherwise (no) step S754 repeats until the service information is received.

The received service information is then stored to the service information database 64 in step S756. A service list is then generated in step S758 based on the service name contained in the received service information, and the generated service list is presented on the display 61 in step S760. Control then goes to step S762. In step S762 the user is requested to select the service to be received from the displayed service list and the service selection is then input from the input device 60. In step S764 the service information for the selected service is then read from the service information database 64 and control goes to step S766.

In step S766, based on the device-to-device communication information contained in the read service information, communication between the network device 210 connected to the home gateway 200 and the related service device is relayed through the home gateway. The process then ends and control returns to the previous process.

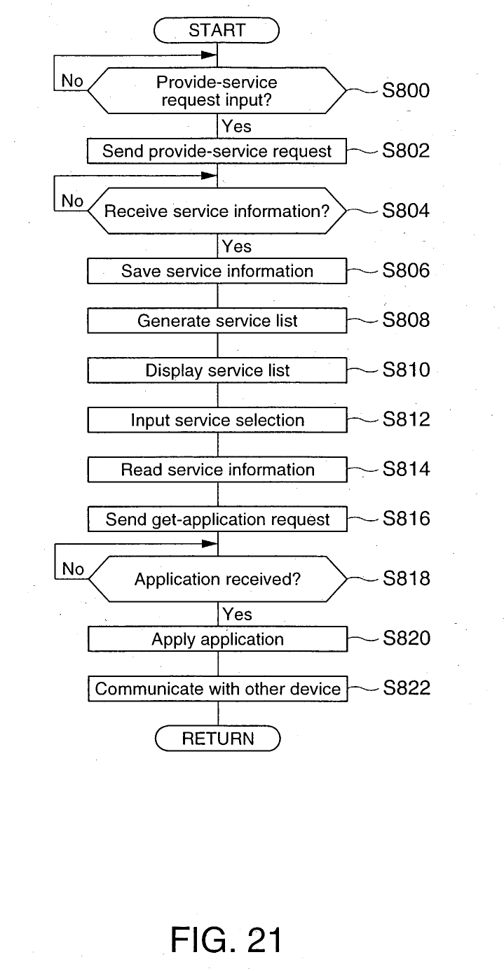

The second service-providing process is described in detail next with reference to FIG. 21, which is a flow chart showing that process. The second service-providing process corresponds to the second service-information-providing process shown in FIG. 13. This second service-providing process differs from the first service-providing process of FIG. 20 in that the former applies an application to the home gateway 200.

When this process is run by the CPU 50, it starts from step S800 as shown in FIG. 21. Whether a provide-service request was input from the input device 60 is first determined in step S800. If a provide-service request was input (yes) control goes to step S802, otherwise (no) step S800 repeats until a provide-service request is input.

In step S802 the provide-service request is sent to the device management server 100. Whether service information was received is then determined in step S804. If service information was received (yes), control goes to step S806, otherwise (no) step S804 repeats until the service information is received.

The received service information is then stored to the service information database 64 in step S806 and control goes to step S808 where a service list is generated based on the service name contained in the received service information. The resulting service list is then presented on the display 61 in step S810 and control goes to step S812.

The user is then prompted to select the service to be provided from the displayed service list in step S812 and the user inputs the service selection from the input device 60. Service information for the selected service is then read from the service information database 64 in step S814, and control goes to step S816.

In step S816 a get-application request is then sent based on the application information contained in the read service information, and whether the application was received or not is determined in step S818. If the application was received (yes) control goes to step S820. If the application was not received (no), step S818 repeats until the application is received.

In step S820 the received application is applied to the home gateway 200 and control goes to step S822 where communication between the network device 210 connected to the home gateway 200 and the related service device is relayed between the home gateway based on the device-to-device communication information contained in the read service information. The process then ends and control returns to the previous process.

Operation of the illustrated embodiments of the invention are described next.

Registering user information in the device management server 100 is described first. To register user information the user first inputs a user information registration request to the home gateway 200. The user information includes the user name, user password, and contact address information. When a registration request and user information are input to the home gateway 200, the input user information and registration request are sent to the device management server 100 (steps S508, S510).

When the device management server 100 receives the registration request and user information it generates a user ID and saves the received user information and resulting user ID as one user information record in the user information database 40, and returns the resulting user ID to the home gateway 200 that sent the registration request (steps S104 to S108).

When the home gateway 200 receives the user ID it saves the user ID with the input user information as one user information record in the user information database 62, and then returns a registration-completed report to the device management server 100 (steps S514, S516).

The user can thus register his own user information in the device management server 100.

Registering device information with the device management server 100 is described next. To register device information the user first inputs the device information registration request to the home gateway 200.

When a device information registration request is input, the home gateway 200 gets the device information from the network device(s) 210 by communicating with the network device(s) 210 connected thereto and prompts the user to select one of the network devices 210 connected to the home gateway 200 (steps S552, S554). When the user selects one of the network devices 210 the user ID is read from the user information database 62 and acquired as the administrator ID (step S556). The device information and registration request are then sent to the device management server 100 (steps S558, S560).

When the device management server 100 receives the registration request and device information it generates the device ID and saves the received device information and resulting device ID to the device information database 41 as one device information record, and sends the device ID to the home gateway 200 from which the registration request was received (steps S154 to S158).

When the home gateway 200 receives the device ID it saves the received device ID and acquired device information as one device information record to the device information database 63, and returns a registration-completed report to the device management server 100 (steps S564, S566).

The user can thus register device information about the user's own network devices 210 in the device management server 100.

Registering service information in the device management server 100 is described next. To register service information the user first inputs a service information registration request to the home gateway 200 together with the service information. The service information includes the service name, device-to-device communication information, application information, and type of network device 210.

When the registration request and service information are input to the home gateway 200, the user ID is read from the user information database 62 and acquired as the administrator ID (step S610). The input service information and registration request are then sent to the device management server 100 (steps S612, S614).

When the device management server 100 receives the registration request and service information it generates a service ID and stores the received service information and resulting service ID as one service information record to the service information database 42 (steps S204, S206).

The user can thus define a specific service in the device management server 100.

Registering group information to the device management server 100 is described next. To register group information the user first inputs a group information registration request to the home gateway 200, and inputs the group name and group password as group information.

When the registration request and group information are input, the home gateway 200 reads the user ID and user password from the user information database 62 and acquires the read user ID as the administrator ID (steps S656). The input group information and read user password are then sent with the registration request to the device management server 100 (step S658).

When the registration request, group information, and user password are received, the device management server 100 reads the user password corresponding to the administrator ID contained in the received group information from the user information database 40 and determines if the received user password matches the user password read from the database (steps S254, S256). If the user password matches, a group ID is generated and the received group information and resulting group ID are stored as one group information record to the group information database 43 (steps S258, S260).

The user can thus create groups on the device management server 100

Enabling a user to participate in a group is described next.

For a user to participate in a group the user must first input a join-group request together with the group name and group password to the home gateway 200. It should be noted that the group name and group password must be acquired from the group administrator.

When the join-group request, group name, and group password are input, the home gateway 200 reads the user ID and user password from the user information database 62, and then sends the input group name and group password, and the user ID and user password read from the database, as the join-group information together with a join-group request to the device management server 100 (steps S708 to S712).

When the join-group request and join-group information are received, a user ID is contained in the received join-group information. The device management server 100 therefore finds the user password for the user ID in the join-group information from the user information database 40, and determines if the user password in the join-group information matches the user password read from the database (steps S306, S308). The group password for the group name contained in the join-group information is then read from the group information database 43, and whether the group password in the join-group information matches the group password for the database is determined (steps S310, S312). If both passwords match, the user ID in the join-group information is stored to the member list of the corresponding group information (steps S314).

A user can thus join a group on the device management server 100. The user can join a group created by another user or a group created by the user.

Adding a network device 210 to a group is described next.

For a network device 210 to join a group the user must first input a join-group request to the home gateway 200, and input the group name and group password. The group name and group password must be acquired from the administrator that created the group.

When a join-group request, group name, and group password are input, the home gateway 200 prompts the user to select one of the network devices 210 connected to the home gateway 200 (step S714). When the user selects one of the network devices 210, the device ID for the selected network device 210 is read from the device information database 63, and the input group name, group password, and retrieved device ID are sent as the join-group information with the join-group request to the device management server 100 (steps S716 to S720).

A device ID is contained in the join-group information received with the join-group request. The device management server 100 therefore reads the group password for the group name contained in the join-group information from the group information database 43, and determines if the group password in the join-group information and the group password from the database match (steps S316, S318). If the passwords match, the device ID in the join-group information is stored to the member list of the corresponding group information (steps S320).

A user can therefore add a network device 210 managed by the user to a group on the device management server 100. The user can add the device to a group created by another user or to a group that the user created.

Using another network device 210 is described next.

To use another network device 210 the user first inputs a provide-service request to the home gateway 200. In order to access a service the user information, device information, service information, and group information must already be registered with the device management server 100.

When a provide-service request is input, the home gateway 200 sends the provide-service request to the device management server 100 (step S752). When a service request is received, the device management server 100 reads from the group information database 43 the group information for the group to which the user of the home gateway 200 from which the service request originated belongs (step S352). Based on the retrieved group information and the service information from service information database 42, network device 210 connected to home gateway 200 and a network device 210 linked thereto to provide the service are identified from among the network devices 210 belonging to users in the same group as the service-related devices (step S354). Service information for the service-related devices is then retrieved from the service information database 42 and the acquired service information is sent to the requesting home gateway 200 (steps S356, S358).

When service information is received by the home gateway 200, the received service information is stored in the service information database 64, a service list is generated based on the service names contained in the received service information, and the resulting service list is displayed (steps S756 to S760). When the user then selects the desired service, service information for the selected service is retrieved from the service information database 64, and, based on the device-to-device communication information contained in the retrieved service information, communication between the network device 210 connected to the home gateway 200 and service-related device is relayed through the home gateway (steps S762 to S766).

If, for example, a user in home A wants to send a document by fax to home B, the home A user simply selects a fax service using the network printer in home B. When the fax service is selected the network scanner in home A and the network printer in home B are connected as described above so that they can communicate with each other. Once the scanner and printer are communicatively connected and the document to be faxed is scanned with the scanner in home A, the document is sent by the network scanner to the network printer in home B through the home gateways 200 in home A and home B.

A case in which an application is needed to use another network device 210 is described next.

If an application is needed to use another network device 210, the user first inputs a provide-service request to the home gateway 200. As noted above, the user information, device information, service information, and group information must already be registered in the device management server 100 in order to send a provide-service request.

When a provide-service request is input, the home gateway 200 sends the request to the device management server 100 (steps S802).

When the service request is received, the device management server 100 reads the group information for the group to which belongs the user of the home gateway 200 that sent the service request from the group information database 43 (steps S402). Next, in step S404, based on the read group information and the service information from service information database 42, the network device 210 connected to the home gateway 200 and the network device 210 linked thereto to provide the service are identified from among the network devices 210 of the users in the same group as the service-related devices. The service information for the service-related devices is then read from the service information database 42 and sent to the requesting home gateway 200 (steps S406 and S408).

When the home gateway 200 receives the service information, it stores the received service information to the service information database 64, generates a service list based on the service names contained in the received service information, and displays the resulting service list (steps S806 to S810). When the user selects the desired service, the service information for the selected service is read from the service information database 64 and a get-application request is sent based on the application information contained in the read service information (step S814). Because the address of the device management server 100 is set in the application information at this time, the get-application request is sent to the device management server 100.

When the device management server 100 receives the get-application request, it reads the requested application from the application database 44 and returns the application to the home gateway 200 that requested it (steps S412, S414).

When the home gateway 200 receives the application it applies the application to the home gateway 200 (step S820). Based on the device-to-device communication information contained in the read service information, communication between the network device 210 connected to the home gateway 200 and the related service device is relayed by the home gateways 200 (step S822).

With this embodiment of the invention, when a provide-service request is received, the device management server 100 sets the network device 210 connected to the home gateway 200 and the network device 210 linked thereto to provide a particular service based on the service information from the service information database 42 when a provide-service request is received. It then reads and sends the service information for the service-related devices from the service information database 42 to the home gateway 200. The home gateway 200 then sends a provide-service request to the device management server 100. When service information is received in response to this request, the home gateway 200 displays a service list based on the received service information, and, when a service is selected from the displayed service list, relays communication between the network device 210 connected to the home gateway 200 and the service-related device based on the device-to-device communication information contained in the received service information for the selected service.

As a result, because a network device 210 defined as a service device can be used by simply sending a provide-service request from the home gateway 200 to the device management server 100, network devices 210 can be shared relatively easily compared with the prior art. Furthermore, if usable network devices 210 are defined as service devices, the home gateway 200 does not need to query a particular network device 210 to determine if it is accessible for use, and even network devices 210 that are unknown to the network device 210 user can therefore be used.

Furthermore, when the home gateway 200 receives service information, it generates a service list based on the service names contained in the received service information. Because a service list is thus generated based on service names by the home gateway 200, the user can easily know what services can be used.

Moreover, when the device management server 100 receives a service request, it reads the group information for the group associated with the user of the home gateway 200 from the group information database 43, and, based on the read group information and service information retrieved from the service information database 42, defines the network device 210 connected to the home gateway 200 and the network device 210 linked thereto to provide the service from among the network devices 210 of the users in the same group as service-related devices.

By thus grouping users and enabling only users in one group to use network devices 210 belonging to other users in the same group, the possibility of users that do not belong to the group using the network devices 210 can be reduced and security can be relatively improved.

Furthermore, when the device management server 100 in this embodiment receives a provide-service request it reads the group information for the group to which the network device 210 of the home gateway 200 belongs from the group information database 43, and, based on this read group information and the service information from the service information database 42, identifies the network device 210 connected to the home gateway 200 and the network device 210 linked thereto to provide the requested service as the service-related devices of the network devices 210 belonging to the same group.

Because the network devices 210 are grouped and only network devices 210 belonging to the same group can use other network devices 210 in the same group, the possibility of network devices 210 being used by a network device 210 that does not belong to the group can be reduced and security can be relatively improved.

Furthermore, when a desired service is selected from the service list, the home gateway 200 in this embodiment gets an application based on application information contained in the received service information for the selected service, and applies the acquired application to the home gateway 200.

The network devices 210 can therefore be easily shared even when a particular application is required to receive the service because the home gateway 200 is able to get and apply the required application based on the service information from the device management server 100.

Incidentally, the device management server 100 in the above embodiment is an example of the device administration terminal described in the claims; the home gateway 200 is an example of the gateway terminal described in the claims.

It will be further noted that in the above embodiment the steps shown in the flow charts in FIG. 15 to FIG. 21 are performed by the home gateway 200, but the invention is not so limited. These steps could, for example, be performed by the network device 210. In this case, the network device 210 could be connected directly to the Internet 199 without using a home gateway 200. Thus, network devices 210 defined for a service specified in a provide-service request can be used by means of the network device 210 sending a provide-service request directly to the device management server 100, and the network devices 210 can therefore be easily shared compared with the prior art.

Furthermore, if a usable network device 210 is defined as a service, even network devices 210 that are unknown to the user can be used without the network device 210 querying whether another network device 210 can be used.

Moreover, while the service information registration is handled by the home gateway 200 in the above embodiment, the invention is not so limited. Any terminal connected to the Internet 199 could store the service information. Because these services are more likely to be defined and provided by service vendors than the owner of a particular home gateway 200 or network device 210, the service information is preferably stored at a service vendor terminal rather than the home gateway 200.

Yet further, while the application is adapted to the home gateway 200 in the above embodiment, the invention is not so limited. Rather, the invention could be configured to adapt the application to the network device 210.

While deleting user information has thus far not been mentioned, it will be apparent to those skilled in the art that user information can also be deleted. To delete user information the user inputs the user name and user password, and sends the user name and user password with a user information deletion request to the device management server 100. When the device management server 100 receives the user information deletion request with the user name and user password, it verifies the user based on the received user name and password, then deletes the user information for the indicated user, deletes all device information, service information, and group information for which the user is the designated administrator, and deletes the user and all network devices 210 for which the user is the administrator from the member lists of all groups to which the user belongs.

It will also be apparent that device information can be deleted. To delete device information the user inputs the user name, user password, and indicates the network device 210 for which device information is to be deleted, and then sends the input user name and password and network device 210 selection together with a device information deletion request to the device management server 100. When the device management server 100 receives the device information deletion request, user name, user password, and network device 210 selection, it verifies the user based on the received user name, user password, and network device 210 selection, then deletes the device information for the indicated network device 210, and deletes the network device 210 from the member lists of all groups to which the network device 210 belongs.

Likewise, as will be apparent, service information can be deleted. To delete the service information the user inputs the user name, user password, and indicates the service for which service information is to be deleted, and then sends the input user name and password and service selection together with a service information deletion request to the device management server 100. When the device management server 100 receives the service information deletion request, user name, user password, and service selection, it verifies the user based on the received user name, user password, and service selection, and then deletes the service information for the indicated service.

Group information can also be deleted. To delete group information the user inputs the user name, user password, group name and group password, and then sends the input user name and password and group name and password together with a group information deletion request to the device management server 100. When the device management server 100 receives the group information deletion request, user name, user password, group name and group password, it verifies the user and group based on the received user name, user password, group name and group password, verifies that the user is the group administrator, and then deletes the group information for the indicated group.

Removing a user from a group was also not specifically described in the above embodiment, but it will be apparent that a user can be removed from a group. To remove a user from a group, the user enters the user name, user password, group name, and group password, and sends the user name, user password, group name, and group password together with a remove-from-group request to the device management server 100. When the device management server 100 receives the remove-from-group request together with the user name, user password, group name, and group password, it verifies the user and group based on the received user name, user password, group name, and group password, and then removes the user from the member list of the indicated group.

A network device 210 can also be removed from a group. To remove a network device 210 from a group, the user enters the user name, user password, group name, group password, and network device 210 selection, and sends the user name, user password, group name, group password and network device 210 selection together with a remove-from-group request to the device management server 100. When the device management server 100 receives the remove-from-group request together with the user name, user password, group name, group password, and network device 210 selection it verifies the user and group based on the received user name, user password, group name, group password, and network device 210 selection, and then removes the network device 210 from the member list of the indicated group.

A network scanner and a network printer are used as examples of network devices 210 in the above embodiment, but the invention is not so limited. Other possible network devices include, for example, network-capable projectors, digital cameras, digital video cameras, personal computers, personal digital assistants (PDAs), network storage devices, audio equipment, cell phones, PHSs (Personal Handyphone Systems) handsets, watch-type PDAs, POS (point-of-sale) terminals, photocopiers, facsimile machines, telephones (including Internet Protocol (IP) telephones), exchange equipment, Network Control Units (NCU), and other network-capable devices and equipment.

Furthermore, the processes shown in the flow charts in FIG. 7 to FIG. 13 are described above as being run with a control program previously stored in ROM 32, but the invention shall not be so limited. For example, a program embodying the steps of these processes could be read from any desirable storage medium into RAM 34 and executed from there.

Likewise, the processes shown in the flow charts in FIG. 15 to FIG. 21 are described above as being run with a control program previously stored in ROM 52, but the invention is not so limited. For example, a program embodying the steps of these processes could be read from any desirable storage medium into RAM 54 and executed from there.

These storage media could be a semiconductor storage device such as RAM or ROM, a magnetic storage medium such as a floppy disk or hard disk, an optically-readable storage medium such as a CD, CDV, LD, or DVD, a magnetically-writable/optically-readable storage medium such as magneto-optical discs, or any other type of computer-readable storage media regardless of the reading method, including electronic, magnetic, optical, or other suitable media.

The device sharing system, device administration terminal, gateway terminal, device, terminal program and device program, and method for providing a device-sharing system is described in the above embodiment adapted to the Internet 199 as the network system. The invention is not so limited, however, and could be applied to an intranet enabling communication in the same way as the Internet 199. The invention can be applied to any type of network system.

Furthermore, in the present embodiment the device sharing system, device administration terminal, gateway terminal, device, terminal program and device program, and method for providing a device-sharing system defines plural services achieved by linking at least two network devices 210 located in homes A to C as shown in FIG. 1, and provides services using these network devices 210 by connecting the required network devices 210 to communicate with each other in response to a received provide-service request. The invention shall not be so limited, however, and can be adapted within the scope of the present invention to various other scenarios. For example, the invention could be used to provide services using network devices 210 located in different parts of a company.

As described above a device-sharing system can use devices defined for a specifically requested service by simply asserting a provide-service request, and sharing devices is thus easy compared with the prior art. Furthermore, if usable devices are defined as services, even devices unknown to the user of a device can be used without querying the device to determine whether it can be used.

Moreover, because a gateway terminal can use a device defined for a service relating to a provide-service request by simply sending a provide-service request to the device administration terminal with the device-sharing system, devices can be shared easily when compared with the prior art.

Furthermore, if usable devices are defined as services, even devices unknown to the user of a device can be used without the gateway terminal querying the device to determine whether it can be used.

The gateway terminal of the device-sharing system can display a service list based on service identification information, thereby making it easier to know what services can be used.

Furthermore, the device-sharing system puts users into groups and enables only users in a given group to use devices belonging to users in the same group. The possibility of users not belonging to the group using those devices is thus reduced and security is relatively improved.

In addition, the device-sharing system puts devices into groups and enables only devices in a given group to use devices belonging to the same group. The possibility of devices being used by devices not belonging to the same group is thus reduced and security is relatively improved.

The gateway terminal of the device-sharing system gets and applies a required application based on service information received from a device administration terminal when a particular application is required to receive a particular provided service. Sharing devices is thus even easier.

With the device-sharing system a device can use other devices designated for a service indicated by a provide-service request by simply sending a provide-service request to the device administration terminal. Devices can thus be shared more easily compared with the prior art.

Furthermore, if usable devices are defined as services, even devices unknown to the device-using side can be used without the device querying other devices to determine whether those devices can be used.

While the invention has been described in conjunction with preferred embodiments thereof, many further alternatives, modifications, variations and applications will be apparent to those skilled in the art that in light of the foregoing description. Thus, the invention described herein is intended to embrace all such alternatives, modifications, variations and applications as may fall within the spirit and scope of the appended claims.

What is claimed is:

1. A device-sharing system for enabling communication between a device administration terminal and a plurality of gateway terminals, each associated with at least one device and configured to establish communication between the at least one associated device and other devices through their respective gateway terminals, each device in the system being able to perform or receive one or more of a plurality of services available on the system, the system comprising:
a service information storage medium configured to store, for each service, information relating to that service including device-to-device communication information enabling communication between devices used for that service;
wherein, when the device administration terminal receives a provide-service request, the device administration terminal
identifies as service-related devices (i) a device of the gateway terminal from which the provide-service request originated and (ii) at least one device linked thereto to perform the requested service, based on service information from the service information storage medium, and
reads service information for the service-related devices from the service information storage medium, and sends the read service information for the service-related devices to the request-originating gateway terminal, and
wherein, the gateway terminal from which the provide-service request originated, upon receiving service information from the device administration terminal in response to the request, displays a service list based on the received service information, and, when a service is selected from the displayed service list, relays communication between the gateway terminal device from which the provide-service request originated and the at least one device linked thereto to obtain performance of the requested service, based on device-to-device communication information contained in the received service information for the selected service.

2. A device-sharing system as described in claim 1, wherein the service information for each service includes service identification information for identifying that service, and wherein the gateway terminal displays a service list when service information is received, based on the service identification information of the service or services in the list.

3. A device-sharing system as described in claim 1, further comprising
a group information storage medium for storing group information relating to groups to which multiple users can belong,
wherein the device administration terminal, when a provide-service request is received, reads from the group information storage medium group information for the group to which the user of the gateway terminal from which the provide-service request originated belongs, and, based on the read group information and service information from the service information storage medium, identifies the service-related devices from that group.

4. A device-sharing system as described in claim 1, further comprising
a group information storage medium for storing group information relating to groups to which multiple devices can belong;
wherein the device administration terminal, when a provide-service request is received, reads from the group information storage medium group information for the group to which the device of the gateway terminal from which the provide-service request originated belongs, and, based on the read group information and service information from the service information storage medium, identifies the service-related devices from that group.

5. A device-sharing system as described in claim 1, wherein
the service information includes application information denoting a location from which an application to be applied to a device or gateway terminal used in the service can be acquired; and
the gateway terminal, when a service is selected from the service list, acquires an application based on application information contained in the received service information for the selected service, and applies the acquired application to the device or gateway terminal.

6. A device-sharing system for enabling communication between any of a plurality of devices, each being able to perform or receive one or more of a plurality of services available on the system, the system being configured such that, in response to a provide-service request received by a device administration terminal, a communication link between at least one device designated to perform the service requested in the provide-service request and at least one device designated to receive the requested service is established, the device-sharing system comprising:
a service information storage medium configured to store, for each service, service information relating to that service including device-to-device communication information enabling communication between devices used for that service;
wherein, when the device administration terminal receives the provide-service request, the device administration terminal
identifies as service-related devices (i) a device from which the provide-service request originated and (ii) at least one device linked thereto to perform the requested service, based on service information read from the service information storage medium, and
reads service information for the service-related devices from the service information storage medium, and sends the read service information to the request-originating device; and
wherein, the device from which the provide-service request originated, upon receiving service information from the device administration terminal in response to the request, displays a service list based on the received service information, and, when a service is selected from the displayed service list, communicates with the at least one device linked thereto to obtain performance of the requested service, based on device-to-device communication information contained in the received service information for the selected service.

7. A device administration terminal in communication with a plurality of gateway terminals, each having at least one device associated therewith, the device administration terminal comprising:
a service information storage medium configured to store, for each service, information relating to that service including device-to-device communication information enabling communication between devices used for that service;
wherein, when a provide-service request is received by the device administration terminal, the device administration terminal
identifies as service-related devices (i) a device of the gateway terminal from which the provide-service request originated and (ii) at least one device linked thereto to perform the requested service, based on service information from the service information storage medium, and
reads service information for the service-related devices including device-to-device communication information from the service information storage medium, and sends the read service information to the request-originating gateway terminal.

8. A device administration terminal capable of communicating with a plurality of devices, the device administration terminal comprising:
a service information storage medium configured to store, for each service, information relating to that service including device-to-device communication information enabling communication between devices used for that service;
wherein, when a provide-service request is received by the device administration terminal, the device administration terminal
identifies as service-related devices (i) the device from which the provide-service request originated and (ii) at least one device linked thereto to perform the requested service, based on service information from the service information storage medium, and
reads service information for the service-related devices including device-to-device communication information from the service information storage medium, and sends the read service information to the request-originating device.

9. A gateway terminal for establishing communication between a device associated therewith and other devices, each of which is able to perform or receive one or more services, the gateway terminal comprising:
a service information storage medium configured to store, for each service, information relating to the service including device-to-device communication information enabling communication between devices used for the service; and
wherein the gateway terminal is configured to
send a provide-service request to an external device,
receive service information in response to the sent request,
display a service list based on the received service information, and
in response to a service being selected from the displayed service list, relay communication between the gateway terminal device and a service-related device based on device-to-device communication information contained in the received service information relating to the selected service.

10. A device capable of communicating with a device administration terminal in a device-sharing system that facilitates communication between the device and any of a plurality of devices in the system, wherein the device is configured to
send a provide-service request to the device administration terminal,
receive service information in response to the sent request,
display a service list based on the received service information, and
in response to a service being selected from the displayed service list, communicate with at least one service-related device based on device-to-device communication information contained in the received service information for the selected service.

11. A device-readable medium embodying a program to be run by a device administration terminal in communication with a plurality of gateway terminals, each having at least one device associated therewith, the program comprising instructions for:
processing a provide-service request by
identifying as service-related devices (i) a device of the gateway terminal from which the provide-service request originated and (ii) at least one device linked thereto to perform the requested service, based on service information, and
reading service information for the service-related devices including device-to-device communication information, and sending the read service information to the request-originating gateway terminal.

12. A device-readable medium embodying a program to be run by a device administration terminal in communication with a plurality of devices, the program comprising instructions for:
processing a provide-service request by
identifying as service-related devices (i) the device from which the provide-service request originated and (ii) at least one device linked thereto to perform the requested service, based on service information, and
reading service information for the service-related devices including device-to-device communication information, and sending the read service information to the request-originating device.

13. A device-readable medium embodying a program to be run by a gateway terminal configured to establish communication between a device associated therewith and other devices, each of which is able to perform or receive one or more services, the program comprising instructions for:
sending a provide-service request to an external device,
receiving service information in response to the sent request,
displaying a service list based on the received service information, and
in response to a service being selected from the displayed service list, relaying communication between the gateway terminal device and a service-related device based on device-to-device communication information contained in the received service information relating to the selected service.

14. A device-readable medium embodying a program to be run by a device that is capable of communicating with a device administration terminal in a device-sharing system that facilitates communication between the device and any of a plurality of devices in the system, the program comprising instructions for:
sending a provide-service request to the device administration terminal;
receiving service information in response to the sent request;
displaying a service list based on the received service information, and
in response to a service being selected from the displayed service list, communicating with at least one service-related device based on device-to-device communication information contained in the received service information for the selected service.

15. A method for providing a device-sharing service by enabling communication between a device administration terminal and a plurality of gateway terminals, each associated with at least one device and configured to establish communication between the at least one associated device and other devices through their respective gateway terminals, each device in the system being able to perform or receive one or more of a plurality of services available on the system, the method comprising:
storing, for each service, service information relating to that service including device-to-device communication information enabling communication between devices used for that service;
enabling a gateway terminal to send a provide-service request to the device administration terminal;
when a provide-service request is received by the device administration terminal
enabling the device administration terminal to identify as service-related devices (i) a device of the gateway terminal from which the provide-service request originated and (ii) at least one device linked thereto to perform the requested service, based on stored service information, and
enabling the device administration terminal to read service information for the service-related devices, and send the read service information to the request-originating gateway terminal; and
when the service information is received by the gateway terminal from which the provide-service originated in response to the request
enabling that gateway terminal to display a service list based on received service information, and
when a service is selected from the displayed service list, enabling that gateway terminal to relay communication between itself and the at least one device linked thereto to perform the requested service, based on device-to-device communication information contained in the received service information for the selected service.

16. A method for providing a device-sharing service by enabling communication between any of a plurality of devices, each device being able to perform or receive one or more of a plurality of services available on the system, the system being configured such that, in response to a provide-service request received by a device administration terminal, a communication link between at least one device designated to perform the service requested in the provide-service request and at least one device designated to receive the requested service is established, the method comprising:
storing, for each service, service information relating to that service including device-to-device communication information enabling communication between devices used for that service;
when the provide-service request is received by the device administration terminal
enabling the device administration terminal to identify as service-related devices (i) a device from which the provide-service request originated and (ii) at least one device linked thereto to perform the requested service, based on stored service information, and
enabling the device administration terminal to read service information for the service-related devices, and send the read service information to the request-originating device; and
when the service information is received by the device from which the provide-service originated in response to the request
enabling that device to display a service list based on received service information, and
when a service is selected from the displayed service list, enabling that device to relay communication between itself and the at least one device linked thereto to perform the requested service, based on device-to-device communication information contained in the received service information for the selected service.
